(19) United States
(12) Patent Application Publication
(10) Pub. No.: US 2012/0051771 A1
(43) Pub. Date: Mar. 1, 2012

(54) IMAGE FORMING APPARATUS AND CALIBRATION METHOD FOR IMAGE FORMING APPARATUS

(75) Inventor: Takahiro Honda, Osaka (JP)

(73) Assignee: KYOCERA MITA CORPORATION, Osaka (JP)

(21) Appl. No.: 13/221,724

(22) Filed: Aug. 30, 2011

(30) Foreign Application Priority Data
Aug. 31, 2010 (JP) 2010-194241

(51) Int. Cl. G03G 15/00

(52) U.S. Cl. 399/49

(57) ABSTRACT

The image forming apparatus includes a patch image forming unit that forms a patch image on an intermediate transfer member; a background toner density acquisition unit that acquires a background toner density of the intermediate transfer member in the period from a startup time for calibration to elapse of a single-rotation period, and that acquires a background toner density acquisition elapse time; a patch toner density acquisition unit that acquires the toner density of the patch image, and that acquires the patch toner density acquisition elapse time from the elapse time of a single-rotation period to the acquisition of the patch toner density; and a background toner density determination unit that determines the background toner density at the time corresponding to an elapse time that approximates the patch toner density acquisition elapse time as the background toner density at the position at which the patch toner density is acquired.

This application is based on and claims the benefit of priority from Japanese Patent Application No. 2010-194241, filed on 31 Aug. 2010, the content of which is incorporated herein by reference.

### BACKGROUND OF THE DISCLOSURE

### Field of the Disclosure

The present disclosure relates to an image forming apparatus that shortens a calibration time without reducing the accuracy of the calibration, and to a method of the calibration therefor.

In recent years an electrophotographic image forming apparatus has seen progress in relation to a print speed, functional characteristics and color characteristics, and a wide variety of printers have been put to practical use, for example, as the image forming apparatus. A research and development into tandem type image forming apparatuses has been conducted to increase a print speed by arranging a series formed from a plurality of image forming units that forms images having different colors, and by executing image formation by simultaneous operation of those units. The high-speed formation of a color image by a tandem image forming apparatus includes the possibility of broad business applications.

A tandem image forming apparatus mainly employs an intermediate transfer method. An intermediate transfer method firstly superimposes toner images in a plurality of colors on an intermediate transfer member (intermediate transfer belt) (primary transfer), and then executes secondary transfer of all the toner images onto a transfer member (for example, transfer paper (paper, sheet) to thereby complete image formation.

However, an image forming apparatus that uses an intermediate transfer method may exhibit deterioration in the temperature characteristics of a process-control light sensor that reads an image density, or the performance of the process-control light sensor as a result of temporal changes. Consequently, density fluctuations may be present in the read image. Consequently, there is a need to perform calibration (correction) by using the process-control light sensor to read a reference patch. A conventional apparatus is configured to read images and read the reference patch by using a single process-control light sensor enabled, by separate provision of a calibration light sensor for reading of the reference patch in addition to the process-control light sensor or by a drive means that switches the position of a moveable reference plate for mounting of the reference patch.

However, the provision of a designated calibration light sensor for calibration of the process-control light sensor, or the provision of a drive means for switching of the position of the reference patch increases the number of configuring components and control components in the apparatus, and increases the cost of the overall apparatus.

A known image forming apparatus solves the above problems by switching and detecting a reference patch formed on a predetermined reference portion and an image patch formed on an image patch formation portion with the process-control light sensor in response to a separation operation or convergence operation of a transfer bearing member. A process-control means executes calibration and image density adjustment based on the detection result of the process-control light sensor.

The above configuration of the image forming apparatus enables automatic switching between the reference patch and the image patch as the object to be detected by the process-control light sensor in response to a separation operation or a convergence operation of the transfer bearing member, and therefore enables switching and reading of the reference patch and the image patch with a single process-control light sensor. In contrast to the conventional apparatus, the image forming apparatus that has the above configuration avoids the separate provision of a calibration light sensor for reading of the reference patch in addition to the process-control light sensor, and the separate provision of a designated drive means for switching of the object to be detected by the process-control light sensor. As a result, the image forming apparatus with the above configuration does not increase the number of configuring components and control components in the apparatus, and therefore enables a reduction in manufacturing costs.

However, the above technique for an image forming apparatus is a technique that is applied to the calibration of a process-control light sensor, and as a result, there is the problem that application of that method is not possible to other calibration operations executed using a predetermined test image (“test patch”, also termed a “patch”).

Other types of calibration include bias calibration in which a bias value (developing bias value) applied to the development device (development roller) is corrected in response to the toner density of the patch image, or an I/O calibration (also termed “toner density gradation calibration”) in which the inclination of a color output toner density (also termed a “gamma table”) is corrected when the color toner density (output toner density) of an actual image is corrected with reference to a predetermined color toner density (input toner density) of image data.

During execution of these types of calibration, in a step prior to forming a patch pattern for calibration, a background toner density of the intermediate transfer member must be acquired from a predetermined position forming the patch pattern on the intermediate transfer member. This is due to the fact that abrasion or soiling due to use of the intermediate transfer member causes a large deviation in the luminance (background toner density) of the intermediate transfer member depending on the position on the intermediate transfer member. Consequently, in a conventional configuration, a position detection member for determining a specified position on the intermediate transfer member is positioned in advance on the intermediate transfer member, and acquisition of the background toner density is executed in precedence after the detection time of the position detection member by the predetermined detection unit. Then, after at least one rotation of the intermediate transfer member, a patch pattern for calibration as described above is formed on a subsequent occasion after the position detection member is detected. In this manner, it is possible to acquire (detect) the background toner density at the same position and acquire (detect) the toner density of a patch image formed at that position. Therefore high accuracy calibration is possible.

However, in the conventional technique, the detection of the position detection member must be performed once in a step prior to acquisition of the background toner density, or in a step prior to execution of patch pattern formation. Therefore, there is an idle time in the period from the startup of calibration to detection of the position detection member, and as a result, there is the problem that the time required for calibration is increased.

### SUMMARY OF THE DISCLOSURE

The present disclosure is an image forming apparatus and a method of calibration that enables the time required for calibration to be shortened without causing a reduction in calibration accuracy.

The image forming apparatus according to the present disclosure is an image forming apparatus that executes calibration based on background toner density that is the density of the background at a predetermined position on the intermediate transfer member and a patch toner density that is the density of a patch image formed at that position when performing a calibration by use of a patch image formed on the intermediate transfer member.

The image forming apparatus according to the present disclosure includes a patch image forming unit that forms a patch image on the intermediate transfer member, a background toner density acquisition unit that acquires the background toner density acquisition elapse time that is the elapsed time from a startup time to the acquisition time of the background toner density, and that acquires a background toner density of the intermediate transfer member in the period from the startup time for calibration to elapse of a single-rotation period that is the time taken for single rotation of the intermediate transfer member, a patch toner density acquisition unit that acquires the toner density of the patch image formed by the patch image forming unit, and that acquires the patch toner density acquisition elapse time that is the elapsed time from the elapse time of a single-rotation period to the acquisition of the patch toner density, and a background toner density determination unit that determines the background toner density at the time corresponding to an elapse time that approximates the patch toner density acquisition elapse time as the background toner density at the position at which the patch toner density is acquired.

The above configuration enables instantaneous formation of the patch pattern, or acquisition of the background toner density without waiting for detection of the position detection member on the intermediate transfer member. As a result, it is possible to eliminate the waiting time for detection of the position detection member associated with the conventional configuration, thus enabling a large reduction in the time required for calibration. Furthermore, there is almost no reduction in the calibration accuracy since the determined background toner density corresponds to the background toner density at the position at which the patch toner density is acquired.

The image formation method according to the present disclosure provides a method of calibration, when executing calibration by use of a patch image formed on the intermediate transfer member, that performs calibration based on a background toner density at a predetermined position on the intermediate transfer member and the patch toner density based on the toner density of the patch image formed at that position. In other words, the calibration method according to the present disclosure includes a patch image forming step for forming a patch image on the intermediate transfer member, a background toner density acquisition step for acquiring the background toner density acquisition elapse time that is the elapsed time from a startup time to the acquisition time of the background toner density, and acquiring a background toner density of the intermediate transfer member in the period from the startup time for calibration to elapse of a single-rotation period that is the time taken for single rotation of the intermediate transfer member, a patch toner density acquisition step for acquiring the density of the patch image formed by the patch image forming step, and acquiring the patch toner density acquisition elapse time that is the elapsed time from the elapse time of a single-rotation period to the acquisition of the patch toner density, and a background toner density determination step for determining the background toner density at the position at which the patch toner density is acquired as the background toner density at the time corresponding to the elapsed time that approximates the patch toner density acquisition elapse time. The method obtains the same effect as that described above.

The image forming apparatus and the calibration method according to the present disclosure reduce the time required for calibration without reducing the calibration accuracy.

### BRIEF DESCRIPTION OF THE DRAWINGS

FIG. 1 is a schematic view of an image forming apparatus according to an embodiment of the present disclosure.

FIG. 2 illustrates an example of a development unit according to an embodiment of the present disclosure.

FIG. 3 is a schematic block diagram of control hardware for an image forming apparatus according to an embodiment of the present disclosure.

FIG. 4 is a functional block diagram of an image forming apparatus according to an embodiment of the present disclosure.

FIG. 5 is a first flowchart illustrating the execution sequence of an embodiment of the present disclosure.

FIG. 6 is a second flowchart illustrating the execution sequence of an embodiment of the present disclosure.

FIG. 7A is a schematic figure of the intermediate transfer belt B1 at startup of bias calibration according to an embodiment of the present disclosure.

FIG. 7B is a schematic figure of the intermediate transfer belt B1 at acquisition of the background toner density according to an embodiment of the present disclosure.

FIG. 8 illustrates an example of a background toner density table according to an embodiment of the present disclosure.

FIG. 9A illustrates an example of a patch pattern table according to an embodiment of the present disclosure.

FIG. 9B is a schematic figure of a patch pattern for bias calibration according to an embodiment of the present disclosure.

FIG. 10 illustrates an example of a predetermined color toner density—bias value graph according to an embodiment of the present disclosure.

FIG. 11 illustrates an example of a patch toner density table according to an embodiment of the present disclosure.

FIG. 12A is a schematic figure illustrating the positional relationship of the patch when the patch toner density acquisition elapse time shorter than the single-rotation period of the intermediate transfer belt is elapsed.

FIG. 12B is a schematic figure illustrating the positional relationship of the patch when the patch toner density acquisition elapse time longer than the single-rotation period of the intermediate transfer belt is elapsed.

FIG. 13A is a schematic figure illustrating the positional relationship of the patch when a first background toner density acquisition elapse time is longer than the patch toner density acquisition elapse time of the intermediate transfer belt.

FIG. 13B is a schematic figure illustrating the positional relationship of the patch when the patch toner density acquisition elapse time is longer than a first background toner density acquisition elapse time of the intermediate transfer belt.

FIG. 14A is a schematic figure illustrating the length of the intermediate transfer belt required from the startup to the completion of bias calibration according to an embodiment.

FIG. 14B is a schematic figure illustrating the length of the intermediate transfer belt required from the startup to the completion of bias calibration according to a comparative example.

### DETAILED DESCRIPTION OF THE DISCLOSURE

The embodiments of the image forming apparatus according to the present disclosure will be described below making reference to the attached figures. The following embodiments are merely examples of the disclosure, and do not impose a limitation on the technical scope of the present disclosure. The alphabetic script “S” attached before a numeral in the flowcharts means step.

### Image Forming Apparatus

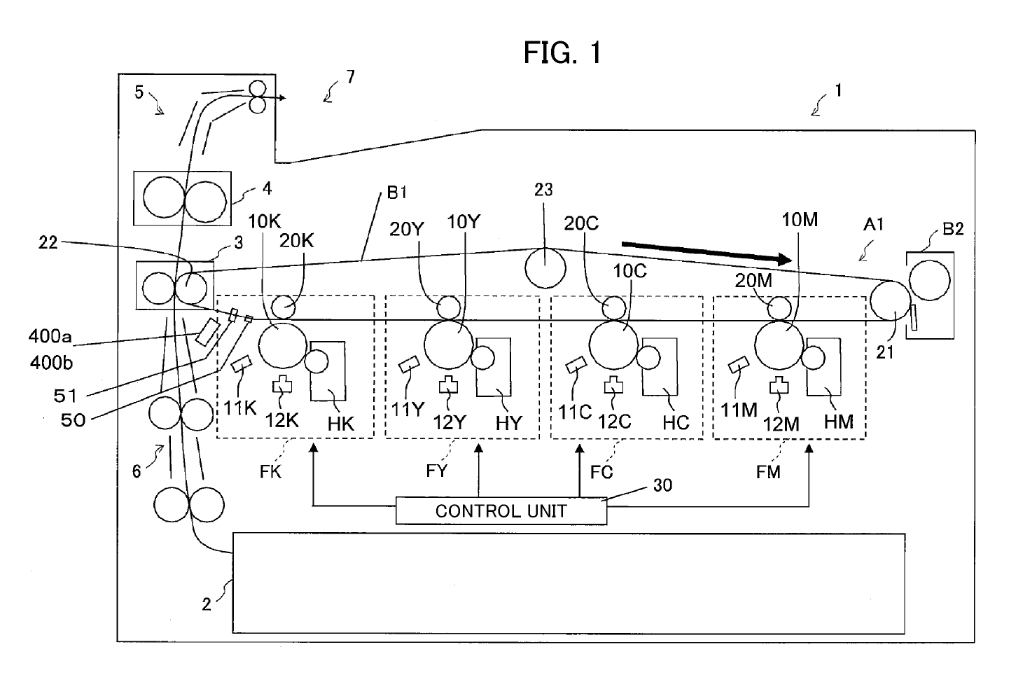

FIG. 1 is a schematic view of an image forming apparatus according to an embodiment of the present disclosure. As illustrated in FIG. 1, the tandem image forming apparatus applying the present disclosure includes image forming units FM, FC, FY, and FK for forming a toner image during color printing. The image forming units FM to FK include an intermediate transfer belt B1, a cleaning unit B2 for cleaning the surface of the intermediate transfer belt B1, and respective photosensitive drums 10M, 10C, 10Y, 10K for magenta development, cyan development, yellow development and black development that are arranged in series in contact with the intermediate transfer belt B1 along the direction of movement of the intermediate transfer belt B1.

A development apparatus HM that uses toner to develop an electrostatic image formed on a peripheral surface of the photosensitive drum 10M, an exposure apparatus 12M for forming an electrostatic latent image, and a charging device 11M for charging the peripheral surface of the photosensitive drum 10M are disposed in close proximity to the magenta photosensitive drum 10M. In the same manner, the photosensitive drums 10C to 10K for cyan, yellow and black are respectively provided with development apparatuses HC to HK, exposure apparatuses 12C to 12K, and charging devices 11C to 11K for charging the peripheral surface of the photosensitive drums 10C to 10K. Respective transfer rollers 20M, 20C, 20Y and 20K are disposed to sandwich the intermediate transfer belt B1 on the peripheral surface of each photosensitive drum 10M to 10K and thereby transfer the respective toner images carried on the peripheral surface of each photosensitive drum 10M to 10K onto the intermediate transfer belt B1.

The intermediate transfer belt B1 is stretched between a driving roller 21 and a driven roller 22 with a predetermined tensile force imparted thereto by a tension roller 23. The intermediate transfer belt B1 displaces in the direction indicated by the arrow, and as a result, the four photosensitive drums 10M to 10K are respectively rotated in a counterclockwise direction as shown in FIG. 1.

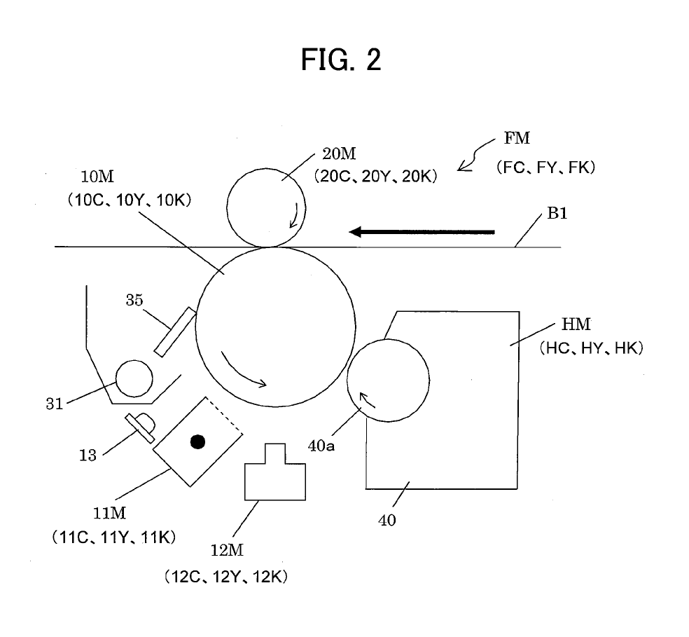

As illustrated in FIG. 2, the peripheral surface of the photosensitive drums 10M to 10K is charged with a preset potential by respective charging devices 11M to 11K. An image that corresponds to the image on the document is written by the respective exposure apparatuses 12M to 12K onto the peripheral surface of each photosensitive drum 10M to 10K, to thereby form an electrostatic latent image. The electrostatic latent images are respectively developed into a toner image of respectively different colors by the development apparatuses HM to HK. Each colored toner image is transferred onto the intermediate transfer belt B1 by the respective transfer rollers 20M to 20K. Then, the toner images are superimposed on the intermediate transfer belt B1.

Toner remaining on the respective surfaces of the photosensitive drums 10M to 10K after the above transfer operation is removed by a blade 35, and discharged into a predetermined container by the discharge roller 31. Thereafter, the surface of the photosensitive drums 10M to 10K is eliminated electricity by the static elimination apparatus 13.

A plurality of sheets of paper P is conveyed by a conveying unit 6 from a cassette 2 adapted to store a plurality of sheets of paper P at a fixed interval to the image forming units FM to FK. The toner image transferred onto the intermediate transfer belt B1 is transferred by the secondary transfer unit 3 to the sheet of paper P conveyed to the image forming units FM to FK.

The control unit 30 controls the operation of the respective image forming member in the image forming units FM to FK including the respective photosensitive drums 10M to 10K, the respective development apparatuses HM to HK, charging devices 11M to 11K, and the respective transfer rollers 20M to 20K. The control unit 30 executes control of the operation of the conveying mechanism including the conveying rollers 21 to 23.

Next, the configuration of the development apparatus HM will be described. Since the configuration of the development apparatuses HC to HK for each color is the same as the development apparatus HM, the description of such configuration will not be repeated.

The development apparatus HM includes a development container 40 and a development roller 40a. The development container 40 stores powdered developer formed from magenta toner particles and a carrier. The development roller 40a is configured in contact with the photosensitive drum 10M. The toner image that corresponds to the image to be formed in accordance with instructions from a higher-order control apparatus such as a personal computer or the like is formed on the surface of the photosensitive drum 10M by the potential difference between the potential of the electrostatic latent image on the surface of the photosensitive drum 10M and the developing bias applied to the development roller 40a (development operation).

The image forming apparatus 1 receives instructions for image formation from a higher-order apparatus, and then uses the image forming units FM to FK to form respective colored toner images corresponding to the instructed image data. The toner images formed by each of the image forming units FM to FK are transferred onto the intermediate transfer belt B1, superimposed on the intermediate transfer belt B1 to thereby form a color toner image.

In synchrony with the formation of the color toner image, the sheets of paper that are stored in the paper storage unit 2 are removed as individual sheets from the paper storage unit 2 by a paper supply apparatus (not shown), and are conveyed on a paper conveying unit 6. The paper sheets are conveyed to the secondary transfer unit 3 in synchrony with the primary transfer timing to the intermediate transfer belt B1. The secondary transfer unit 3 executes secondary transfer of the color toner image on the intermediate transfer belt B1 onto the sheet of paper. The paper sheet after transfer of the color toner image is conveyed to a fixing unit 4, and the color toner image is fixed by heat and pressure. Then, the sheet of paper is discharged by the paper discharge apparatus 5 into the paper discharge tray 7 provided on an upper portion of the outer section of the image forming apparatus 1. After secondary transfer, toner that remains on the intermediate transfer belt B1 is removed from the intermediate transfer belt B1 by a cleaning unit B2 of the intermediate transfer belt B1.

Furthermore, toner density detection sensors 400a, 400b are provided at a predetermined position between the black image forming unit FB and the secondary transfer unit 3. The toner density detection sensors 400a, 400b detect the toner density of the patch image (test patch image) (patch toner density) formed on the intermediate transfer belt B1 and the toner density of the background of the intermediate transfer belt B1 (background toner density) at a predetermined timing. The black image forming unit FB is positioned most downstream in relation to the other image forming units FY, FM, FC with reference to the direction of rotation of the intermediate transfer belt B1. The toner density detection sensors 400a, 400b are configured to detect the patch toner density of any patch images on the intermediate transfer belt B1 formed by any of the plurality of image forming units FY, FM, FC, FB. The toner density detection sensors 400a, 400b are normally positioned in advance to a position corresponding to the position at which the patch image is formed of the intermediate transfer belt B1. In this embodiment of the present disclosure, the toner density detection sensors 400a, 400b are respectively provided in proximity to both longitudinal ends of the intermediate transfer belt B1. The toner density detection sensors 400a, 400b may adopt any configuration to the extent of being a sensor that enables detection of the background toner density and the toner density of the patch image for each color. The toner density detection sensors 400a, 400b are configured from a reflective toner density detection sensor that illuminates light from a light source onto the background on the intermediate transfer belt B1 or the patch image, detects the intensity of the reflected light with a photoreception sensor, and converts the intensity information for the reflected light to a toner density.

Alternatively, a positional detection member 50 (for example, metal film, metal piece, cutout, or the like) that indicates the specific position of the intermediate transfer belt B1 is positioned in advance on the intermediate transfer belt B1. The image forming apparatus 1 is provided with a detection unit 51 (for example, a photosensor) at a position enabling detection of the position detection member 50. The specific position of the rotating intermediate transfer belt B1 is determined by detection of the positional detection member 50 on the intermediate transfer belt B1 by the detection unit 51.

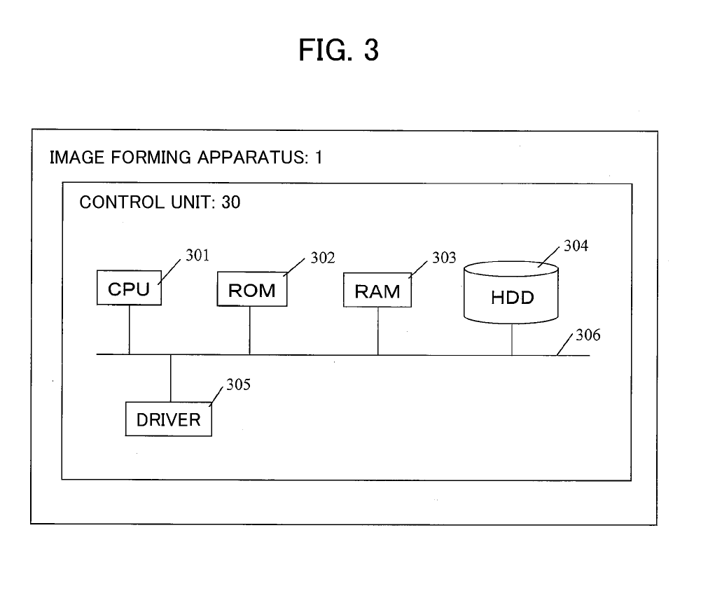

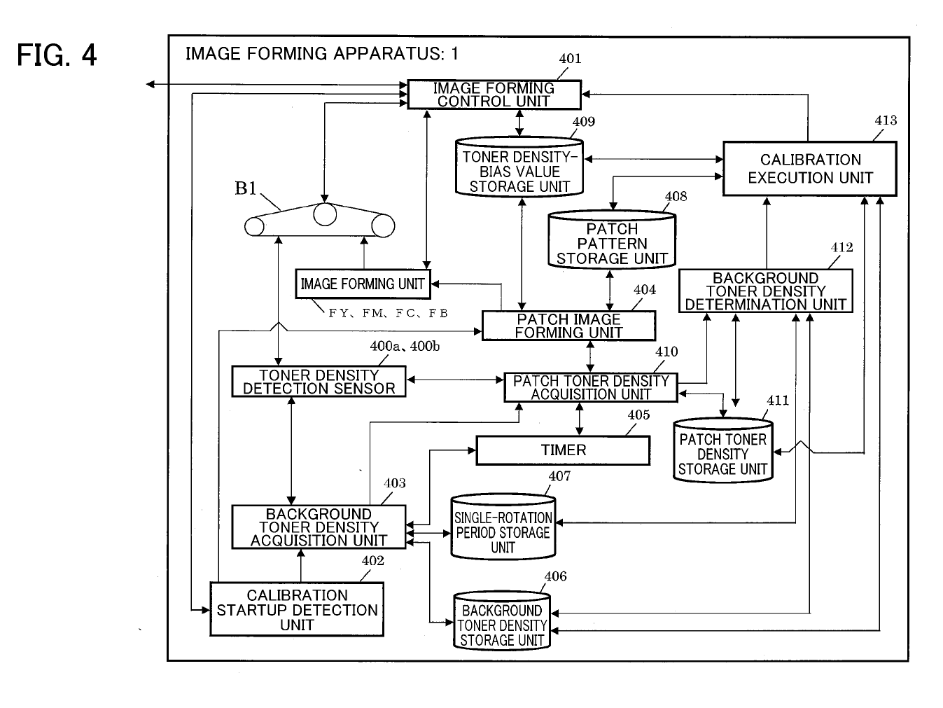

FIG. 3 is a schematic block diagram of control hardware for an image forming apparatus according to an embodiment of the present disclosure. As illustrated by FIG. 3, the image forming apparatus includes a CPU (central processing unit) 301, a RAM (random access memory) 303, a ROM (read only memory) 302, a HDD (hard disk drive) 304, and a driver 305 corresponding to each drive unit during printing. These components are connected by an internal bus 306. The CPU 301 for example controls the operation of each drive unit illustrated in FIG. 1 by uses the RAM 303 as a work area, execution of programs that are stored in the ROM 302, the HDD 304, or the like, and by exchange of data or commands with the driver 305 based on the results of executing the programs. Each unit (illustrated in FIG. 4) described hereafter in addition to the drive units above is operated by execution of programs by the CPU 301.

### Embodiments of the Disclosure

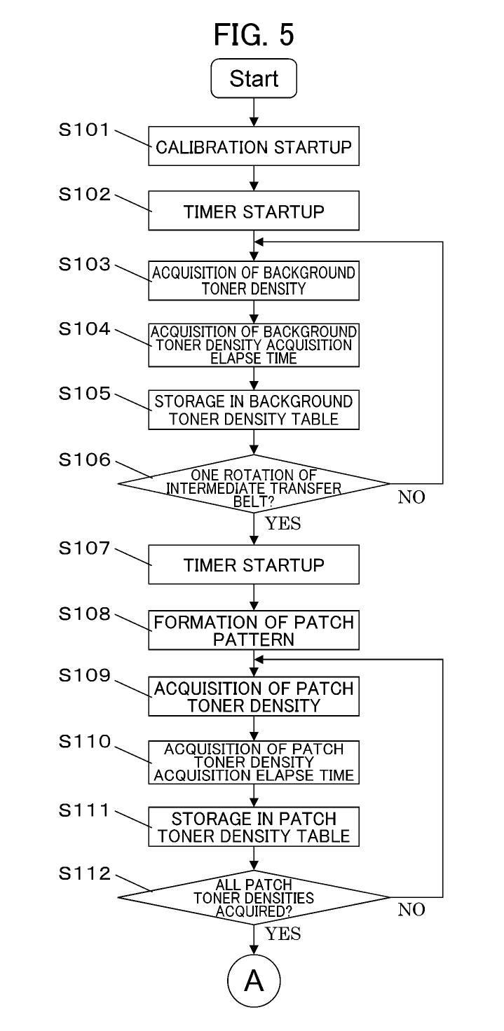

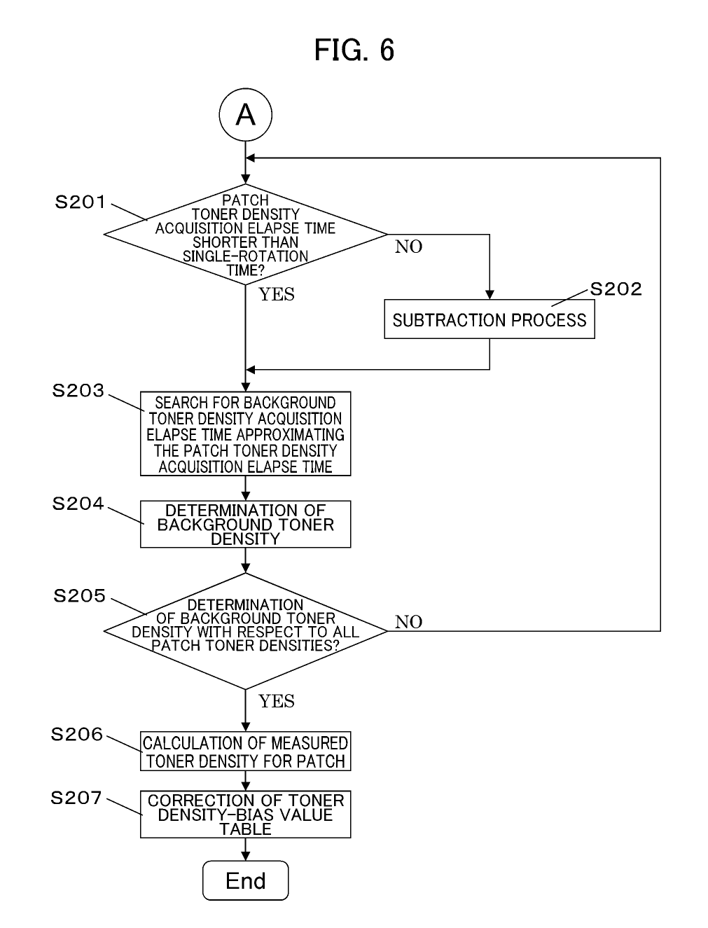

Next, the execution sequence according to an embodiment of the present disclosure will be described making reference to FIG. 4 to FIG. 6. FIG. 4 is a functional block diagram of an image forming apparatus according to an embodiment of the present disclosure. FIG. 5 is a first flowchart illustrating the execution sequence of an embodiment of the present disclosure. FIG. 6 is a second flowchart illustrating the execution sequence of an embodiment of the present disclosure.

As illustrated in FIG. 4, the configuration of the image forming apparatus 1 according to the embodiment of the present disclosure in relation to control operations includes two toner density detection sensors 400a, 400b, an image formation control unit 401, a calibration startup detection unit 402, a background toner density acquisition unit 403, a patch image forming unit 404, a timer 405, a background toner density storage unit 406, a single-rotation period storage unit 407, a patch pattern storage unit 408, a toner density-bias value storage unit 409, a patch toner density acquisition unit 410, a patch toner density storage unit 411, a background toner density determination unit 412, and a calibration execution unit 413.

The function and operation of the control elements 400a to 413 will be described together with the execution sequence while making reference to the flowcharts illustrated in FIG. 5 and FIG. 6.

Firstly, when the image forming apparatus 1 is caused to execute color printing, a user switches on the power of the image forming apparatus 1, and the image forming control unit 401 controls the drive roller 21 and the like to thereby rotate the intermediate transfer belt B1 at a predetermined rotation speed. Then, as illustrated in FIG. 5, the calibration startup detection unit 402 detects the input time of the power source from the image forming control unit 401 (or the startup of rotation of the intermediate transfer belt B1) as the calibration startup time (for example, the start time for bias calibration) (S101 in FIG. 5), and notifies the background toner density acquisition unit 403 and the patch image forming unit 404 to that effect.

The background toner density acquisition unit 403 receives the notification, and causes the timer 405 to measure the elapse time from the startup time of bias calibration (S102 in FIG. 5). The sequence for the patch image forming unit 404 will be described hereafter.

Next, the background toner density acquisition unit 403 starts the two toner density detection sensors 400a, 400b, and starts reading (acquisition) of the background toner density at a predetermined position (the position corresponding to the detection unit of the two toner density detection sensors 400a, 400b) from the startup time for bias calibration.

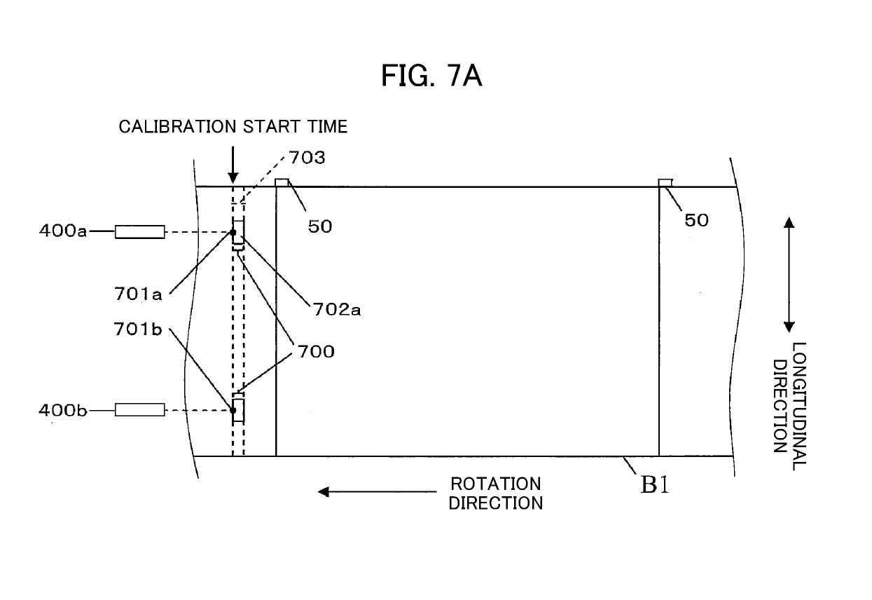

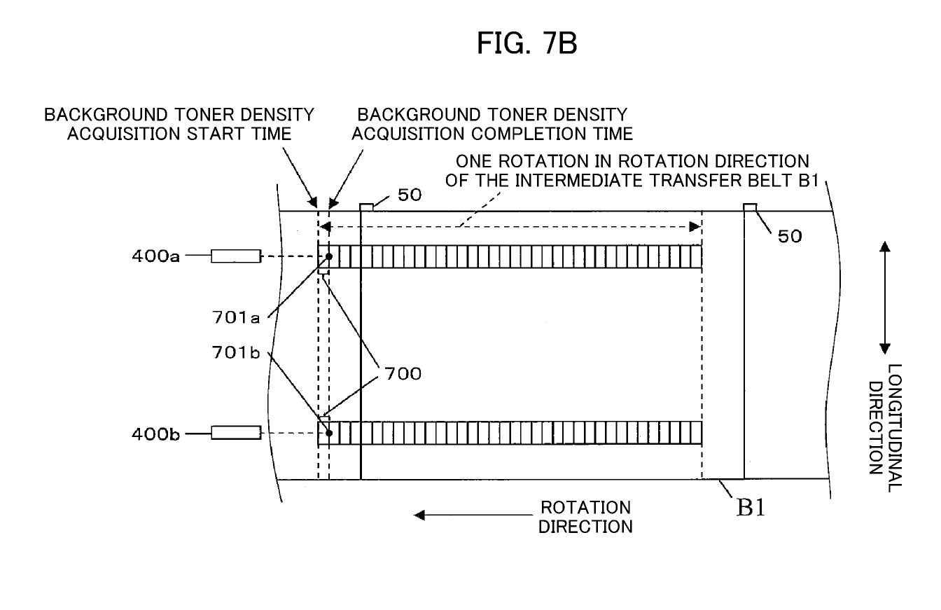

FIG. 7A is a schematic figure of the intermediate transfer belt B1 at startup of bias calibration according to an embodiment of the present disclosure. FIG. 7B is a schematic figure of the intermediate transfer belt B1 at acquisition of the background toner density according to an embodiment of the present disclosure.

When the background toner density acquisition unit 403 reads the background toner density at the predetermined position, and as illustrated in FIG. 7A, the background toner density acquisition unit 403 reads the background toner density 702a of the intermediate transfer belt B1 using the detection unit 701a of one of the toner density detection sensors 400a (the toner density detection sensor on the longitudinal right end) by a preset and predetermined length 700 (the length in the rotation direction of the intermediate transfer belt B1. For example, several cm). Then, the background toner density acquisition unit 403 uses the average value that is read for the background toner density 702a as the background toner density at the position 703 from the start point for reading the background toner density to a point corresponding to upstream displacement by the predetermined length 700. The predetermined length 700 for example corresponds to the length in the rotation direction of the patch portion used for bias calibration. The operation of the other density detection sensor 400b (the density detection sensor on the left longitudinal end of the position that corresponds to the longitudinal direction of the other toner density detection sensor 400a) is the same.

When the background toner density acquisition unit 403 completes the acquisition of the background toner density at the predetermined position, the elapse time, from the startup time for bias calibration to the time at which acquisition of the background toner density is completed, is acquired from the timer 405 as “a background toner density acquisition elapse time” (S104 in FIG. 5). The background toner density acquisition elapse time corresponding to the predetermined background toner density as illustrated in FIG. 7B corresponds to the elapse time from the acquisition startup time for the background toner density by the intermediate transfer belt B1 to the time of rotation downstream by the predetermined length 700 (the acquisition completion time for the background toner density).

Then, the background toner density acquisition unit 403 acquires the background toner density and the background toner density acquisition elapse time at the predetermined position, and stores the background toner density in the background toner density storage unit 406 in the form of a background toner density table in association with the background toner density acquisition elapse time (S105 in FIG. 5).

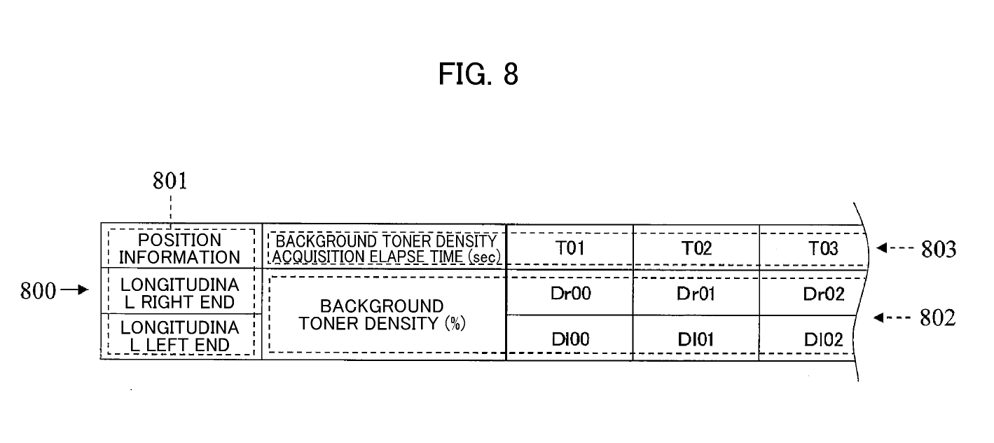

FIG. 8 illustrates an example of a background toner density table according to an embodiment of the present disclosure. As illustrated in FIG. 8, the background toner density table 800 associates and stores position information 801 indicating the position corresponding to the detection units 701a, 701b of the toner density detection sensors 400a, 400b (for example, “longitudinal right end”, “longitudinal left end”), the acquired background toner density 802 (for example, “Dr00”, “D100”) and the acquired background toner density acquisition elapse time 803 (for example, “T01”).

The background toner density acquisition unit 403 acquires a “single-rotation period” stored in advance in the single-rotation period storage unit 407 (the time required for a single rotation (revolution) of the intermediate transfer belt B1). The background toner density acquisition unit 403 determines whether or not the elapse time from the startup time for bias calibration measured by the timer 405 exceeds the single-rotation period acquired by the background toner density acquisition unit 403 (S106 in FIG. 5).

As a result of this determination, when the time elapsing after the startup time for the bias calibration does not exceed the single-rotation period (NO in S106 in FIG. 5), the background toner density acquisition unit 403 repeats acquisition of the background toner density acquisition elapse time and the background toner density at the predetermined position (at each predetermined length) and the storage in the background toner density table 800 (S103→S104→S105 in FIG. 5). In this manner, as illustrated in FIG. 7B, the background toner density acquisition unit 403 acquires the background toner density for the intermediate transfer belt B1 (that is to say, the background toner density for a single rotation in the rotation direction of the intermediate transfer belt B1) throughout the period from the startup time for bias calibration to the time at which the single-rotation period elapses.

The result of this determination when the elapse time from the startup time for bias calibration exceeds the single-rotation period (YES in S106 in FIG. 5) will be described hereafter.

The patch image forming unit 404 receives the notification from the calibration startup detection unit 402, and refers to the patch pattern table that is pre-stored in the patch pattern storage unit 408 and the toner density-bias value graph that is pre-stored in the toner density-bias value storage unit 409.

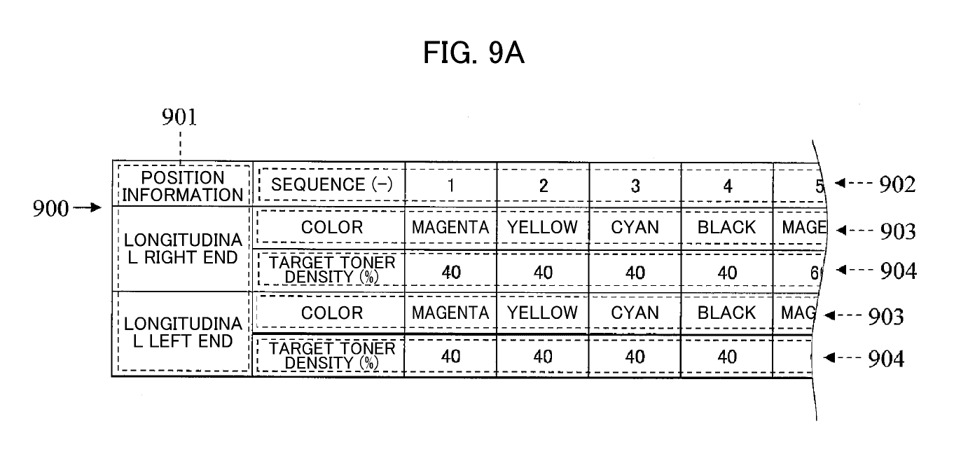

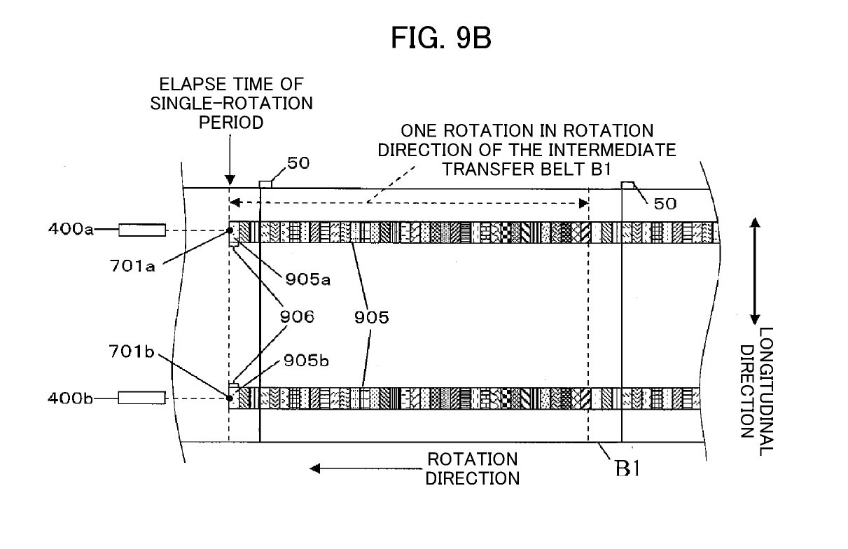

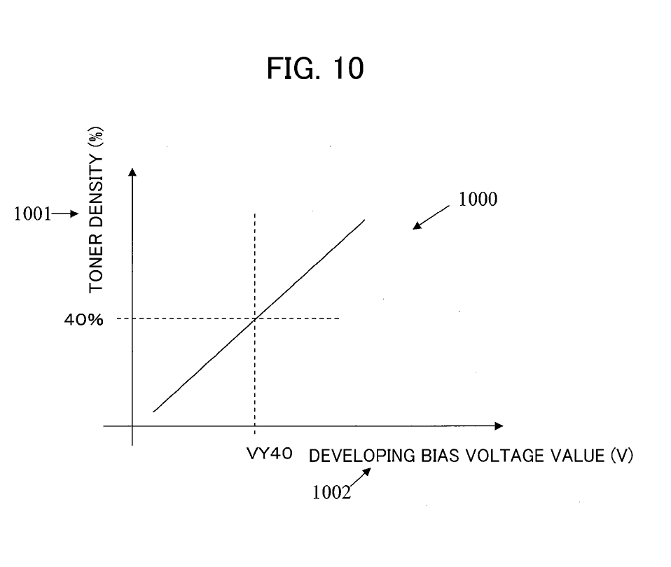

FIG. 9A illustrates an example of a patch pattern table according to an embodiment of the present toner disclosure. FIG. 9B is a schematic figure of a patch pattern for bias calibration according to an embodiment of the present disclosure. FIG. 10 illustrates an example of a predetermined color toner density—bias value graph according to an embodiment of the present disclosure.

The patch pattern table 900 is a table for forming a patch pattern 905 for bias calibration as illustrated in FIG. 9B. As illustrated in FIG. 9A, the patch pattern table 900 associates and stores position information 901 indicating the position corresponding to the detection units 701a, 701b of the toner density detection sensors 400a, 400b (for example, “longitudinal right end” or the like), the sequence 902 of patches configuring the patch pattern 905 (for example, “1”), the patch color 903 (for example, “magenta”), and the color toner density 904 for the patch (for example, “40%”) (also termed “target toner density”).

In addition, as illustrated in FIG. 10, the toner density-bias value graph 1000 is a graph of a predetermined bias value 1002 (units: V (voltage value)) corresponding to a predetermined toner density 1001 (units: %). In an embodiment of the present disclosure, the toner density-bias value graph 1000 is provided for each color since image forming units FY, FM, FC, FB are respectively provided for each color. The toner density-bias value graph 1000 is used when the image forming units FY, FM, FC, FB for each color form an image based on image data.

The patch image forming unit 404 acquires a patch color 903 (“magenta”) and a patch target toner density 904 (“40%”) according to the sequence 902 (“1”) of the patches in the patch pattern table 900 for each position information 901 (“longitudinal right end”, “longitudinal left end”). The patch image forming unit 404 acquires a bias value (for example, “VM40”) corresponding to the target toner density 904 (“40%”) on the toner density-bias value graph 1000 for the color 903 (“magenta”) in FIG. 10. The patch image forming unit 404 uses the acquired bias value (“VM40”) for control of the image forming unit FM for the color 903 (“magenta”), and forms respective patch images at a position on the intermediate transfer belt B1 corresponding to the position information 901 (“longitudinal right end”, “longitudinal left end”). The patch image forming unit 404 forms all patch images based on the patch pattern table 900 to thereby form a patch pattern 905 for bias calibration on the intermediate transfer belt B1.

When the background toner density acquisition unit 403 completes acquisition of the background toner density for a single rotation in the rotation direction of the intermediate transfer belt B1, the patch toner density acquisition unit 410 described below immediately enables acquisition of the patch toner density of the leading patches 905a, 905b and thereby shortens the time required for registration calibration. The patch image forming unit 404 may also start patch pattern formation from the time when acquisition of the background toner density for single rotation of the intermediate transfer belt B1 is completed by the background toner density acquisition unit 403.

The background toner density for a single rotation in the rotation direction of the intermediate transfer belt B1 is obtained when the result of the determination executed by the background toner density acquisition unit 403 indicates that the elapse time from the startup of bias calibration has exceeded the single-rotation period (YES in S106 in FIG. 5). The point (position) of the intermediate transfer belt B1 that initially started bias calibration is returned again to its original point (position) by the rotation of the intermediate transfer belt B1 with reference to the detection units 701a, 701b of the two toner density detection sensors 400a, 400b. The background toner density acquisition unit 403 notifies the patch toner density acquisition unit 410 to that effect. After receipt of the notification, the patch toner density acquisition unit 410 restarts the timer 405, and causes the timer 405 to measure the elapse time from the time that the single-rotation period elapsed (S107 in FIG. 5).

On the other hand, the patch image forming unit 404 forms a patch pattern 905 for bias calibration (or continues formation) intermediate transfer belt B1 at a predetermined timing (S108 in FIG. 5). As a result, the patch toner density acquisition unit 410 acquires the patch toner density for the patches 904a, 905b simultaneously from the two toner density detection sensors 400a, 400b (S109 in FIG. 5).

When the patch toner density acquisition unit 410 acquires the patch toner density, for example, the patch toner density is read only in a length 906 in the rotation direction of the patch, and the average value of the read patch toner density is taken as the patch toner density of the patch image.

Next, when acquisition of the patch toner density is completed, the patch toner density acquisition unit 410 acquires the “patch toner density acquisition elapse time” from the timer 405 which is the elapsed time from the elapsed time of the single-rotation period to the acquisition time for the patch toner density (S110 in FIG. 5).

Furthermore, when the patch toner density acquisition unit 401 acquires the patch toner density and the patch toner density acquisition elapse time, the acquisition sequence for the patch toner density (for example, “1”) together with the patch toner density are associated with the patch toner density acquisition elapse time, and stored in the patch toner density storage unit 411 in the form of a patch toner density table (S111 in FIG. 5).

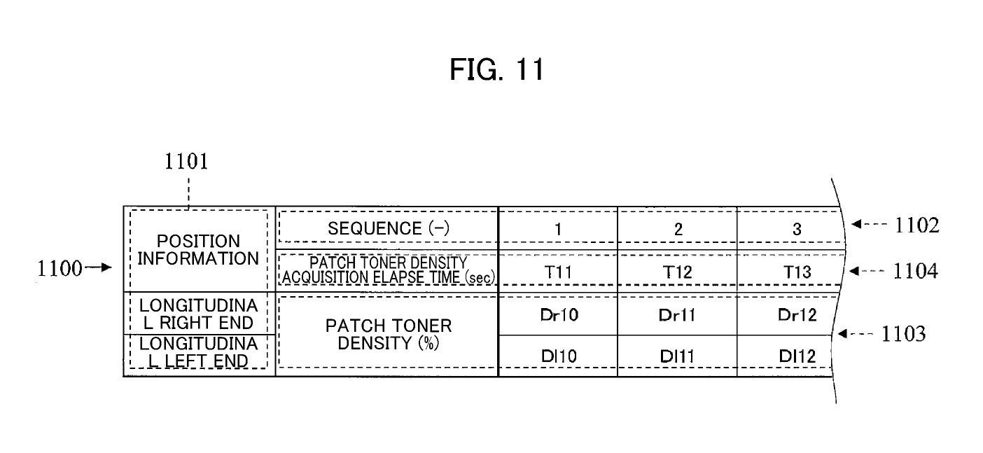

FIG. 11 illustrates an example of a patch toner density table according to an embodiment of the present disclosure. As illustrated in FIG. 11, the patch toner density table 1100 associates and stores position information 1101 indicating the position corresponding to the detection units 701a, 701b of the toner density detection sensors 400a, 400b (for example, “longitudinal right end”, “longitudinal left end”), the acquired patch sequence 1102 (“1”), the acquired patch toner density 1103 (for example, “Dr10”, “D110”) and the patch toner density acquisition elapse time 1104 (for example, “T11”).

When the acquisition of the patch toner density and the patch toner density acquisition elapse time, and storage in the patch toner density table 1100 is not completed for all patches (NO in S112 in FIG. 5), the patch toner density acquisition unit 410 repeats acquisition of the patch toner density and the patch toner density acquisition elapse time and storage in the patch toner density table 1100 in relation to all patch images (patch pattern) formed by the patch image forming unit 404 (S112 NO→S109→S110→S111 in FIG. 5).

When the acquisition of the patch toner density and the patch toner density acquisition elapse time is completed, and the storage in the patch toner density table 1100 for all patches is completed (YES in S112 in FIG. 5), the patch toner density acquisition unit 410 stops the timer 405, and notifies the background toner density determination unit 412 to that effect. The background toner density determination unit 412 receives the notification, and acquires the single-rotation period from the single-rotation period storage unit 406 and acquires the predetermined patch toner density acquisition elapse time 1104 (for example, “T11”) from the patch toner density table 1100. Next, the background toner density determination unit 412 compares the patch toner density acquisition elapse times 1104 with the single-rotation period, and determines whether or not the patch toner density acquisition elapse time 1104 is shorter than the single-rotation period (whether the patch toner density acquisition elapse time 1104 is before or after the single-rotation period) (S201 in FIG. 6).

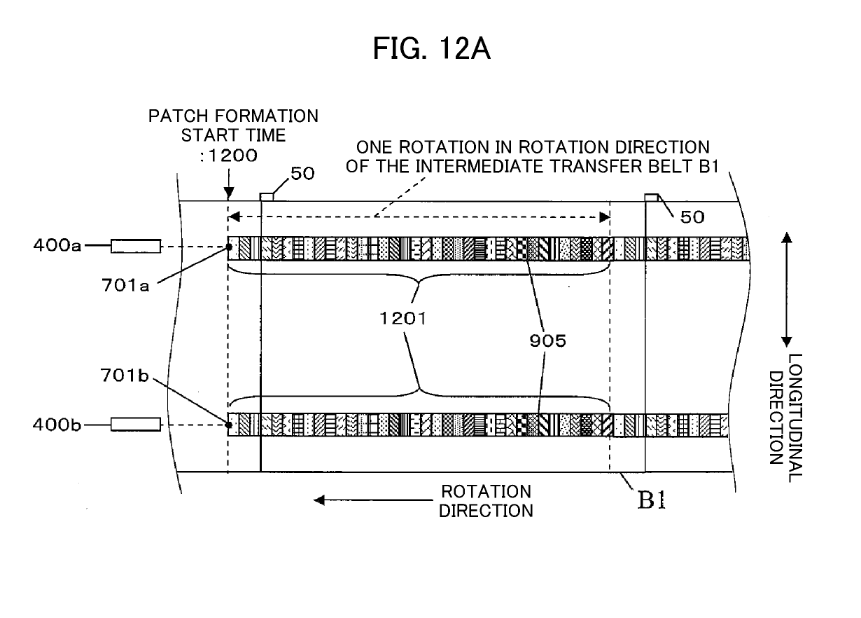

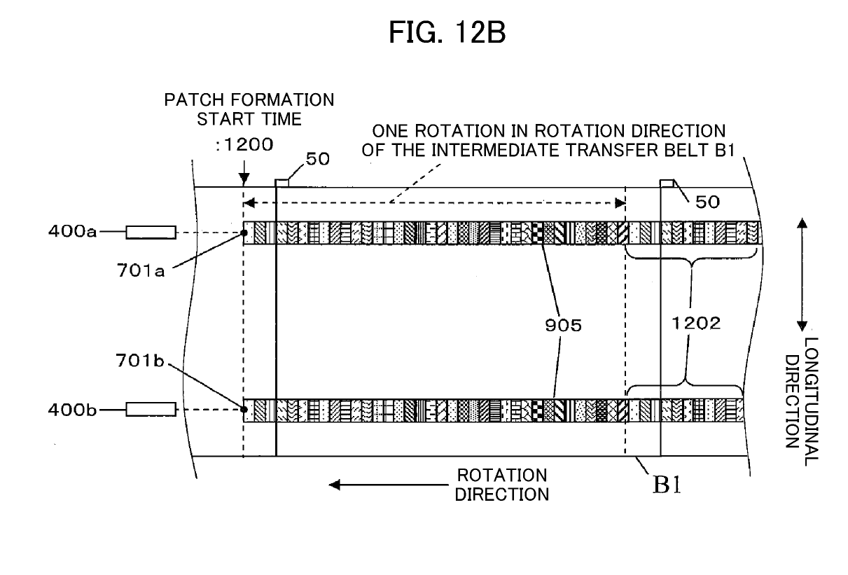

FIG. 12A is a schematic figure illustrating the positional relationship of the patch when the patch toner density acquisition elapse time shorter than the single-rotation period of the intermediate transfer belt is elapsed. FIG. 12B is a schematic figure illustrating the positional relationship of the patch when the patch toner density acquisition elapse time longer than the single-rotation period of the intermediate transfer belt is elapsed.

As illustrated in FIG. 6, when the determination indicates that the patch toner density acquisition elapse time 1104 is shorter than the single-rotation period (YES in S201 in FIG. 6), as illustrated in FIG. 12A, the patch 1201 that has the patch toner density 1103 at the elapse time of the patch toner density acquisition elapse time 1104 is the patch that is formed in the interval from the position of the detection units 701a, 701b of the two toner density detection sensors 400a, 400b to the single rotation of the intermediate transfer belt B1 at the time 1200 when the single-rotation period elapses for the first time. The patch toner density acquisition elapse time 1104 is the time that most closely approximates (including the case in which the patch toner density acquisition elapse time corresponds with the background toner density acquisition elapse time) any of the background toner density acquisition elapse times 803 in the background toner density table 800 that stores the background toner density for the single-rotation period. The background toner density determination unit 412 starts searching the background toner density table 800 for the background toner density acquisition elapse time 803 that approximates the patch toner density acquisition elapse time 1104 (S203 in FIG. 6). The searching operation will be described below.

On the other hand, when the determination indicates that the patch toner density acquisition elapse time 1104 is longer than the single-rotation period (NO in S201 in FIG. 6), as illustrated in FIG. 12B, the patch 1202 that has the patch toner density 1103 at the elapse time of the patch toner density acquisition elapse time 1104 is the patch image that is formed from the position of the detection units 701a, 701b at the time 1200 when the single-rotation period elapses for the first time to after the single rotation of the intermediate transfer belt B1. As a result, the patch toner density acquisition elapse time 1104 does not approximate any of the background toner density acquisition elapse times 803 in the background toner density table 800 as described above. Therefore, the background toner density determination unit 412 shortens the patch toner density acquisition elapse time 1104 to less than the single-rotation period by executing one deduction of the single-rotation period from the patch toner density acquisition elapse time 1104 (S202 in FIG. 6).

When the patch toner density acquisition elapse time 1104 is not less than the single-rotation period even after deduction of the single-rotation period on a single occasion from the patch toner density acquisition elapse time 1104, the background toner density determination unit 412 shortens the patch toner density acquisition elapse time 1104 to less than the single-rotation period by executing a plurality of deductions (for example, twice) of the single-rotation period from the patch toner density acquisition elapse time 1104. In this manner, accurate searching of a background toner density acquisition elapse time 803 that approximates the patch toner density acquisition elapse time 1104 is possible. The number of deductions of the single-rotation period for example may be used as a quotient (integer part) obtained by dividing the single-rotation period from the patch toner density acquisition elapse time 1104 before deduction (the patch toner density acquisition elapse time that is longer than the single-rotation period).

When the background toner density determination unit 412 searches for a background toner density acquisition elapse time 803 that approximates the patch toner density acquisition elapse time 1104 (S203 in FIG. 6), firstly, the shortest background toner density acquisition elapse time (for example “T01”, taken as the first background toner density acquisition elapse time) of the background toner density acquisition elapse times 803 in the background toner density table 800 is acquired. The background toner density determination unit 412 compares the acquired first background toner density acquisition elapse time (“T01”) with the patch toner density acquisition elapse time (“T11”).

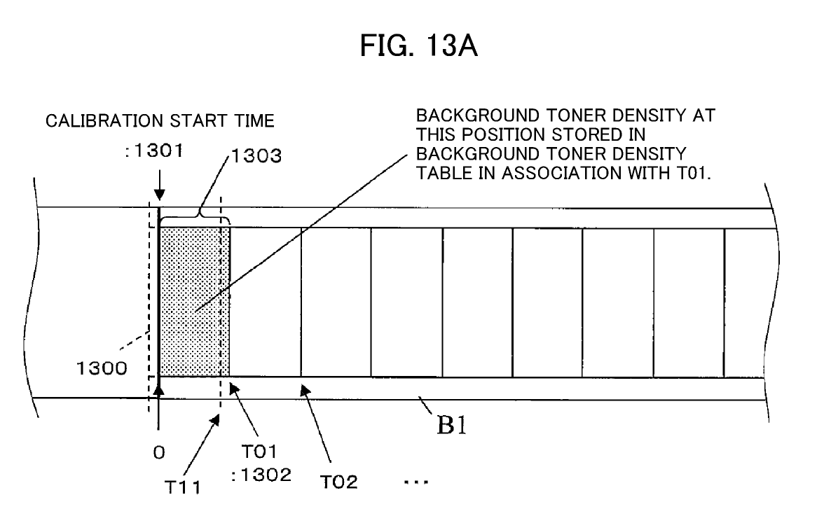

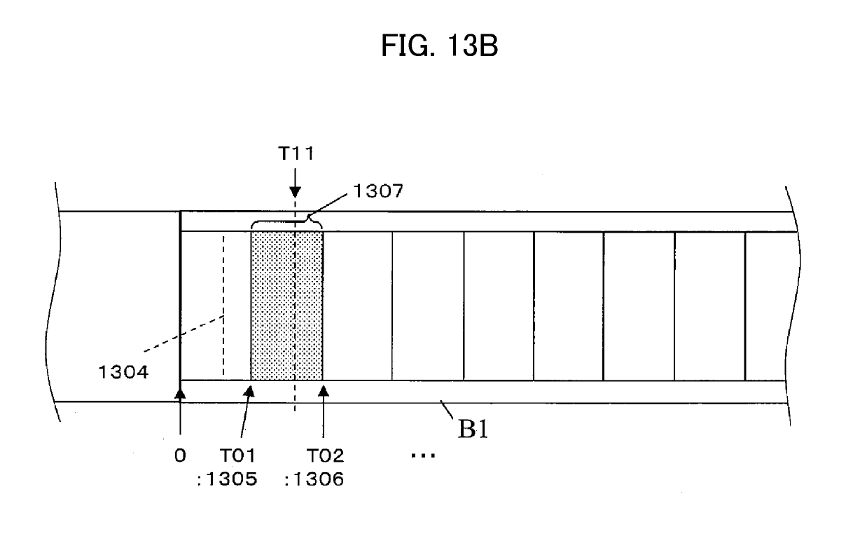

FIG. 13A is a schematic figure illustrating the positional relationship with the patch when a first background toner density acquisition elapse time is longer than the patch toner density acquisition elapse time in the intermediate transfer belt. FIG. 13B is a schematic figure illustrating the positional relationship with the patch when the patch toner density acquisition elapse time is longer than a first background toner density acquisition elapse time in the intermediate transfer belt.

As a result of the comparison, when it is determined that the patch toner density acquisition elapse time (“T11”) is shorter than the first background toner density acquisition elapse time (“T01”) (when the patch toner density acquisition elapse time is before the first background toner density acquisition elapse time), the patch toner density acquisition elapse time (“T11”) is taken as the time from the calibration start time “0 sec” to the first background toner density acquisition elapse time (“T01”). As illustrated in FIG. 13A, the patch 1300, that has a patch toner density 1103 at the elapse time when the patch toner density acquisition elapse time 1104, is superimposed and formed on the position 1303 (region) of the intermediate transfer belt B1 from the calibration start point 1301 to the elapse time 1302 for the first background toner density acquisition elapse time (“T01”). As a result, the background toner density determination unit 412 takes the first background toner density acquisition elapse time (“T01”) as a background toner density acquisition elapse time that approximates the patch toner density acquisition elapse time (“T11”).

As a result of the comparison, when it is determined that the patch toner density acquisition elapse time (“T11”) is longer than the first background toner density acquisition elapse time (“T01”) (when the patch toner density acquisition elapse time is after the first background toner density acquisition elapse time), the background toner density determination unit 412 acquires the background toner density acquisition elapse time of the greatest length after the first background toner density acquisition elapse time (“T01”) (for example, “T02”, taken as the second background toner density acquisition elapse time) from the background toner density table 800. The background toner density determination unit 412 then compares the acquired second background toner density acquisition elapse time (“T02”) with the patch toner density acquisition elapse time (“T11”), and determines whether or not the patch toner density acquisition elapse time (“T11”) is shorter than the second background toner density acquisition elapse time (“T02”) (whether or not the patch toner density acquisition elapse time is before or after the second background toner density acquisition elapse time).

If it is assumed that the patch toner density acquisition elapse time (“T11”) is shorter than the second background toner density acquisition elapse time (“T02”), as illustrated in FIG. 13B, the patch 1304 that that has a patch toner density 1103 at the elapse time of the patch toner density acquisition elapse time 1104 is superimposed and formed on the position 1307 (region) of the intermediate transfer belt B1 from the elapse time 1305 of the first background toner density acquisition elapse time (“T01”) to the elapse time 1306 of the second background toner density acquisition elapse time (“T02”). As a result, the background toner density determination unit 412 takes the second background toner density acquisition elapse time (“T02”) as a background toner density acquisition elapse time that approximates the patch toner density acquisition elapse time (“T11”).

In this manner, the background toner density determination unit 412 searches for a background toner density acquisition elapse time 803 that most closely approximates the patch toner density acquisition elapse time 1104 by repeating a comparison of the patch toner density acquisition elapse time 1104 with the background toner density acquisition elapse time 803 that is lengthened in a stepwise manner (S203 in FIG. 6).

When the search is completed, the background toner density determination unit 412 determines that the background toner density 802 (“Dr00”, “D100”) in the background toner density table 800 that corresponds to the searched background toner density acquisition elapse time 803 (for example, “T01”) is the background toner density at the position at which the patch toner density 1103 (“Dr10”, “D110”) is acquired at the elapse time of the patch toner density acquisition elapse time (“T11”) (S204 in FIG. 6). In this manner, even when a conventional detection operation is not executed by the position detection member 50 of the intermediate transfer belt B1, acquisition is enabled of a background toner density at substantially the same position of formation of a patch that has a predetermined patch toner density.

However, the dimensional relationship between the time interval of the background toner density acquisition elapse times and the time interval of the patch toner density acquisition elapse times may not enable a complete match between the position (region) of background toner density acquisition and the position (region) of patch toner density acquisition. In other words, a slight non-overlapping portion may result in relation to the position of the acquisition of background toner density and the position of the acquisition of patch toner density acquisition. However, the fluctuation in the background toner density is relatively moderate compared to the length in the rotation direction of the intermediate transfer belt B1 (less than several % per several cm), and therefore the background toner density can be accurately determined at a position that approximates the position of the acquisition of the patch toner density. Consequently, a reduction in the calibration accuracy resulting from the above fluctuation in the background toner density is sufficiently small as to not cause a problem.

When the comparison of the single-rotation period the patch toner density acquisition elapse times, the search of the background toner density acquisition elapse times, and the determination of the background toner density are not completed (NO in S205 in FIG. 6), the background toner density determination unit 412 repeats the comparison of the single-rotation period and the patch toner density acquisition elapse times, the search of the background toner density acquisition elapse times, and the determination of the background toner density in relation to all patch toner density acquisition elapse times stored in the patch toner density table 1100 (NO in S205→S201 in FIG. 6).

When the comparison, search and determination of all patch toner density acquisition elapse times are completed (YES in S205 in FIG. 6), the background toner density determination unit 412 notifies the calibration execution unit 413 to that effect. The calibration execution unit 413 receives the notification, and matches the position information 1101 in the patch toner density table 1100 to the position information 801 in the background toner density table 800, and deducts the previously determined background toner density 802 in the background toner density table 800 (for example, “Dr09”) from the patch toner density 1103 (for example, “Dr10”) of the patch toner density table 1100. Then, the calibration execution unit 413 calculates the subtraction value as a measured toner density of the patch image (S206 in FIG. 6). The calibration execution unit 413 executes the calculation of this type of measured toner density for each patch toner density 1103 in the patch toner density table 1100.

Then, the calibration execution unit 413 matches the sequence 1102 of the patch toner density table 1100 with the sequence 902 of the patch pattern table 900, and acquires a target toner density 904 from the patch pattern table 900 corresponding to the previously calculated measured toner density for the patches (of a predetermined sequence). Furthermore, the calibration execution unit 413 uses the toner density-bias value graph 1000 to acquire the bias value (the bias value before correction, for example, “VM40”) used in the image forming units FY, FM, FC, FB when forming the patches in the sequence. Then, the calibration execution unit 413 uses the toner density-bias value graph 1000 to calculate the bias value that matches the target toner density and the measured toner density with reference to the bias value before correction. The calculated bias value is used as the bias value after correction.

The calibration execution unit 413 performs calculations in respect of all bias values after correction for the plurality of measured toner density in the patches having a predetermined color. The calibration execution unit 413 then reconstitutes the toner density-bias value graph based on the plurality of corrected bias values and the plurality of measured toner densitys, and rewrites (corrects) the toner density-bias value graph 1000 (before correction) that is stored in the toner density-bias value storage unit 410 with the reconstituted toner density-bias value graph 1000 (S207 in FIG. 6). In this manner, the correction of the bias value is completed. Correction of the bias value is performed in relation to all colors.

When correction of the bias value is completed, the calibration execution unit 413 notifies the image forming control unit 401 to that effect. The image forming control unit 401 receives the notification, and executes image formation using the image data received from a user, the corrected toner density-bias value graph 1000 and the image forming units FY, FM, FC, FB. In this manner, superior quality is enabled with respect to image formation.

### Examples and Comparative Examples, Operation and Effect of the Embodiment of the Present Disclosure

When providing an example exhibiting the effect as described above, some differences in the effect could be considered to result from the length or the like in the rotation direction of the patch pattern, the length of the single rotation of the intermediate transfer belt B1 of the like. However, differences in relation to the time required for the calibration when executing a bias calibration in addition to image quality after calibration are evident in relation to an image forming apparatus 1 (Example) including the configuration of the embodiment of the present disclosure (a background toner density acquisition unit 403, a patch image forming unit 404, a patch toner density acquisition unit 410, and a background toner density determination unit 412), and an image forming apparatus (comparative example) configured in the same manner as the example with the exception of lacking the configuration of the embodiment of the present disclosure.

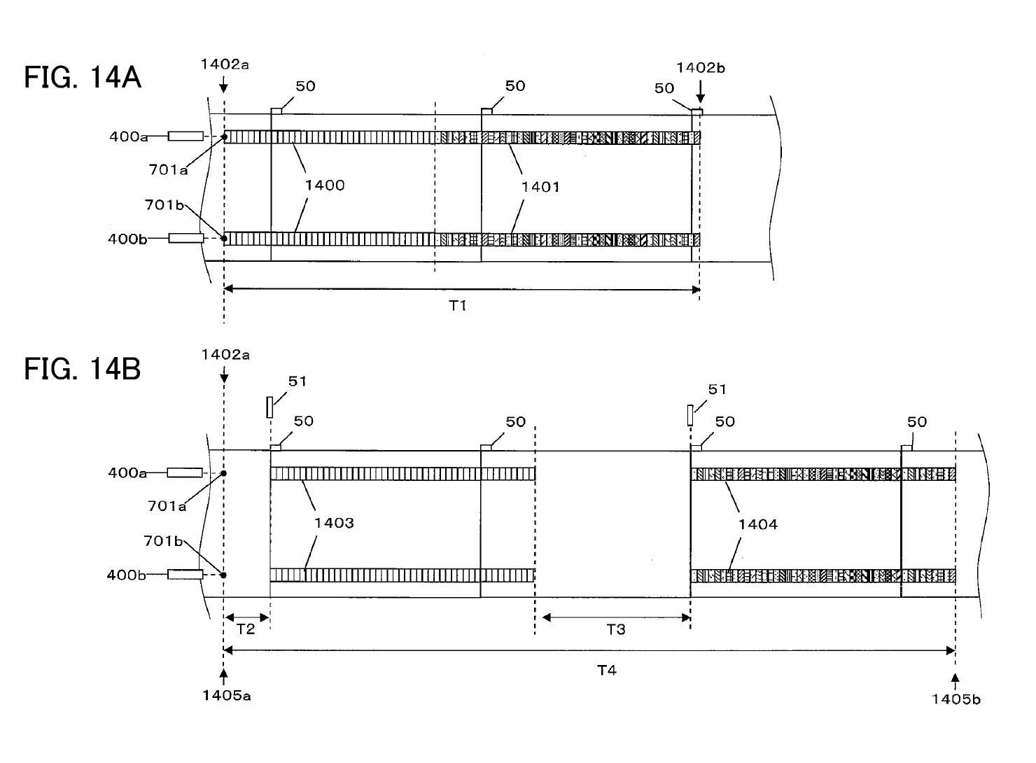

FIG. 14A is a schematic figure illustrating the length of the intermediate transfer belt required from the startup to the completion of bias calibration according to an embodiment. FIG. 14B is a schematic figure illustrating the length of the intermediate transfer belt required from the startup to the completion of bias calibration according to a comparative example.

In the example, as illustrated in FIG. 14A, when bias calibration is started, the background toner density 1400 is simultaneously acquired in relation to a single rotation of the intermediate transfer belt B1. When the patch pattern 1401 is formed in advance and the intermediate transfer belt B1 undergoes a single rotation (when the single-rotation period has elapsed), detection of the patch toner density of the leading patch on the patch pattern 1401 is started. As a result, rapid progression in the calibration operation is enabled. When the time T1 from the calibration start time 1402a to the calculation completion time 1402b is measured, the time T1 is several tens of seconds (for example, 30 to 40 seconds), thereby enabling confirmation of rapid calibration. Furthermore, the example executed immediately after calibration obtained an image without visual defects and with an absence of a problem in relation to calibration accuracy when full-color printing was performed using on predetermined image data.

In contrast, as illustrated in FIG. 14B, when calibration is started in a comparative example corresponding to the conventional technique, firstly, a wait time T2 that corresponds to the period until the position detection member 50 of the intermediate transfer belt B1 is detected by the detection unit 51 is produced. If it is assumed that the calibration start time is immediately after the detection of the position detection member 50 of the intermediate transfer belt B1 by the detection unit 51, the resulting wait time T2 corresponds to the single-rotation period of the intermediate transfer belt B1.

Next, when the position detection member 50 of the intermediate transfer belt B1 is detected by the detection unit 51, the acquisition 1403 of the background toner density is started. Then, when acquisition of a background toner density is completed in relation to a length corresponding to the length in the rotation direction of the preset formed patch pattern, the detection of position detection member 50 of the intermediate transfer belt B1 is performed on a subsequent occasion in order to form an accurate patch pattern at the same position as the acquired background toner density. Therefore, a wait time T3 until the position detection member 50 of the intermediate transfer belt B1 is re-detected by the detection unit 51 is produced.

When the position detection member 50 is detected, formation of the patch pattern 1404 is started, and calibration is executed based on the patch pattern 1404. When the time T4 from the calibration start time 1405a (1402a) to the calibration completion time 1405b is measured, the time T4 is from several tens of seconds to several hundreds of seconds (for example, 70 seconds to 100 seconds). In the comparative example immediately after execution of calibration, when full-color printing is executed based on the same image data as the image data printed in the example, an image was obtained that was substantially equivalent to the image obtained in the example.

Therefore, it was confirmed that when compared with the comparative example, the example does not cause a reduction in calibration accuracy and enables a reduction in the time required for calibration.

An embodiment of the present disclosure includes a background toner density acquisition unit 403 that acquires a background toner density of the intermediate transfer member in the period from a calibration startup time to an elapse time of a single rotation, and that acquires the background toner density from the startup time to the background toner density acquisition time (background toner density acquisition elapse time), a patch toner density acquisition unit 410 that acquires the patch toner density of the patch image formed by a patch image forming unit 404, and acquires the patch toner density acquisition elapse time that is the time from the elapse time of a single rotation to the acquisition of the patch toner density, and a background toner density determination unit 412 that determines the background toner density at the position at which the patch toner density is acquired as the background toner density at the time corresponding to an elapse time that approximates the patch toner density elapse time for the patch toner density.

In this manner, immediate execution is enabled in relation to the acquisition of the background toner density or the formation of the patch pattern without waiting for the detection of the position detection member 50 on the intermediate transfer belt B1. As a result, a considerable reduction in the time required for calibration is enabled by eliminating the waiting time associated with the conventional technique for detection of the position detection member 50. Furthermore, the determined background toner density causes almost no reduction in calibration accuracy since the determined background toner density corresponds to the background toner density at the acquisition position of the patch toner density.

Although the calibration in this embodiment of the present disclosure has been described using an example of bias calibration, the disclosure is not limited thereby. Calibration may include other calibration requiring a background toner density, for example, I/O calibration.

In this embodiment of the present disclosure, the patch image forming unit 404 may be configured by connection of a plurality of patch patterns used for calibration requiring a background toner density in series along the rotation direction of the intermediate transfer belt B1.

This configuration enables continuous execution of a plurality of calibration operations requiring a background toner density without waiting for detection of the position detection member 50 on the intermediate transfer belt B1. Since the background toner density for a single rotation in the rotation direction of the intermediate transfer belt B1 has already been acquired, irrespective of the position of patch formation on the intermediate transfer belt B1, a background toner density at that position can be suitably determined. As a result, a considerable reduction in the time required for a plurality of calibration operations is enabled without unnecessary waiting time for detection of the position detection member 50.

The embodiment of the present disclosure may be configured by provision of a position detection member 50 positioned in advance on the intermediate transfer belt B1, and a single-rotation period measurement unit that measures the single-rotation period based on the detection unit 51 that detects the position detection member 50 when the intermediate transfer belt B1 undergoes a single rotation (for example, when printing in color/monochrome, or when the drive unit required for image formation is warming up, or the like).

This configuration enables an increase in calibration accuracy. That is to say, the present disclosure enables suitable determination of background toner density at the same position as the acquisition of the patch toner density corresponding to the increasing accuracy of the single-time rotation time, and as a result, there is a corresponding increase in the calibration accuracy. The intermediate transfer belt B1 is subjected to thermal expansion due to heat produced during printing or the like, and loosening due to friction or the like. As a result, the single-rotation period of the intermediate transfer belt B1 undergoes temporal fluctuation. Even when the single-rotation period of the intermediate transfer belt undergoes temporal fluctuation by reason of thermal expansion, frictional loosening or the like, the progressive measurement of the single-rotation period avoids any effect of the above temporal fluctuation, and therefore background toner density can be determined with a high accuracy. The single-rotation period used by the background toner density acquisition unit 403 and the background toner density determination unit 412 is preferably the single-rotation period measured immediately prior to starting calibration.

In the embodiment of the present disclosure, although the calibration startup detection unit 402 is configured to detect the input time for the power source as the calibration startup time, there is no limitation in this respect. For example, the calibration startup detection unit 402 may be configured to detect the calibration startup time as the time at which the print number in the image forming control unit 401 exceeds a predetermined threshold, the time at which the printing ratio of printing by the image forming control unit 401 exceeds a predetermined threshold, or the time for warming up of the drive unit required for image formation.

The patch image forming unit 404 in the embodiment of the present disclosure is configured so that the patch pattern 905 for bias calibration is formed on the intermediate transfer belt B1 at the timing at which the leading patch 905a and 905b in the patch pattern 905 reaches the detection unit 701a, 701b of the two toner density detection sensors 400a, 400b, when the intermediate transfer belt B1 undergoes a single rotation. However there is no limitation in this regard. When the patch image forming unit 404 forms the patch pattern 905, the background toner density acquisition unit 403 acquires the background toner density of a single rotation in the rotation direction of the intermediate transfer belt B1. Therefore irrespective of the position of formation of the patch pattern 905 (patch) on the intermediate transfer belt B1, the background toner density relative to the position can be determined.

Furthermore, although a tandem image forming apparatus has been described as an example of the embodiment of the present disclosure, the disclosure is not limited in that regard, and application is possible to all image forming apparatuses that execute printing in a plurality of colors such as an image forming apparatus that uses a rotary development device.

Furthermore, in the embodiment of the present disclosure, although the image forming apparatus 1 is configured by provision of respective units related to control, a configuration may include provision of a storage medium that enables storage of a program for realizing the respective units related to control in the storage medium. This configuration enables reading out of the program by a multifunction peripheral to thereby realize the respective units related to control by the image forming apparatus. In this case, the program itself that is read out of the storage medium may embody the operation and effect of the present disclosure. A method of calibration may be provided in relation to the step executed by the respective units related to control. The program may also enable communication in a storage state in a recording medium enabling reading from the computer such as a CD-ROM, or the like.

As described above, the image forming apparatus and the calibration method according to the present disclosure may be used in relation to a multifunction peripheral, a copying machine, a printer or the like, and enable a reduction in the time required for calibration without reducing the calibration accuracy.

What is claimed is:

1. An image forming apparatus that executes calibration, when executing calibration by use of a patch image formed on the intermediate transfer member, based on a background toner density, the background toner density being the toner density of a background at a predetermined position on an intermediate transfer member, and a toner density of a patch image, the toner density of the patch image being the toner density of a patch image formed at that position, the image forming apparatus comprising:
a patch image forming unit that forms a patch image on the intermediate transfer member,
a background toner density acquisition unit that acquires a background toner density of the intermediate transfer member in the period from a startup time for calibration to elapse of a single-rotation period being the time taken for single rotation of the intermediate transfer member, and that acquires a background toner density acquisition elapse time being the elapsed time from the startup time to the time at which the background toner density is acquired,
a patch toner density acquisition unit that acquires the patch toner density of the patch image formed by the patch image forming unit, and that acquires the patch toner density acquisition elapse time being the elapsed time from the elapse time of a single-rotation period to the acquisition of the patch toner density, and
a background toner density determination unit that determines the background toner density at the time corresponding to an elapse time that approximates the patch toner density acquisition elapse time as the background toner density at the position at which the patch toner density is acquired.

2. The image forming apparatus according to claim 1, wherein the background toner density is determined using a shortened elapse time that is shorter than the single-rotation period by one or more deduction operations of the single-rotation period from the patch toner density acquisition elapse time when the patch toner density acquisition elapse time is longer than the single-rotation period during determination of the background toner density at the acquisition position for the patch toner density.

3. The image forming apparatus according to claim 1, wherein the patch image forming unit forms a patch image as a patch pattern for a plurality of calibrations required for the background toner density, the patch pattern formed continuously in a series along the rotation direction of the intermediate transfer member.

4. The image forming apparatus according to claim 2, wherein the patch image forming unit forms a patch image as a patch pattern for a plurality of calibrations required for the background toner density, the patch pattern formed continuously in a series along the rotation direction of the intermediate transfer member.

5. The image forming apparatus according to claim 1, further comprising a position detection member disposed in advance on the intermediate transfer member, and a single-rotation period measurement unit that measures the single-rotation period when the intermediate transfer member undergoes a single rotation based on the detection unit that detects the position detection member.

6. The image forming apparatus according to claim 2, further comprising a position detection member disposed in advance on the intermediate transfer member, and a single-rotation period measurement unit that measures the single-rotation period when the intermediate transfer member undergoes a single rotation based on the detection unit that detects the position detection member.

7. The image forming apparatus according to claim 3, further comprising a position detection member disposed in advance on the intermediate transfer member, and a single-rotation period measurement unit that measures the single-rotation period when the intermediate transfer member undergoes a single rotation based on the detection unit that detects the position detection member.

8. The image forming apparatus according to claim 4, further comprising a position detection member disposed in advance on the intermediate transfer member, and a single-rotation period measurement unit that measures the single-rotation period when the intermediate transfer member undergoes a single rotation based on the detection unit that detects the position detection member.

9. A method of calibration, when executing calibration by use of a patch image formed on an intermediate transfer member, that performs calibration based on a background toner density being the toner density of a background at a predetermined position on the intermediate transfer member and a patch toner density being the toner density of a patch image formed at the position, the method comprising:
a patch image forming step for forming a patch image on the intermediate transfer member;
a background toner density acquisition step for acquiring a background toner density of the intermediate transfer member in the period from a startup time for calibration to elapse of a single-rotation period that is the time taken for single rotation of the intermediate transfer member, and acquiring the background toner density acquisition elapse time being the elapsed time from the startup time to the acquisition time of the background toner density.
a patch toner density acquisition step for acquiring the patch toner density of the patch image formed by the patch image forming step, and acquiring the patch toner density acquisition elapse time that is the elapsed time from the elapse time of a single rotation to the acquisition of the patch toner density, and
a background toner density determination step for determining the background toner density at the time corresponding to the elapsed time that approximates the patch toner density acquisition elapse time as the background toner density at the position at which the patch toner density is acquired.
